(19) United States
(12) Patent Application Publication
(10) Pub. No.: US 2022/0388262 A1
(43) Pub. Date: Dec. 8, 2022

(54) DEVICE AND METHOD FOR HANDLING TYRES AND TYRE CURING PRESS

(71) Applicant: HARBURG-FREUDENBERGER MASCHINENBAU GMBH, Hamburg (DE)

(72) Inventor: Stefan BAHLKE, Lüneburg (DE)

(21) Appl. No.: 17/770,400

(22) PCT Filed: Oct. 6, 2020
(86) PCT No.: PCT/DE2020/100866

§ 371 Date: Apr. 20, 2022

(30) Foreign Application Priority Data
Oct. 21, 2019 (DE) 10 2019 007 423.8

(51) Int. Cl. B29D 30/00; B29D 30/06

(52) U.S. Cl. CPC B29D 30/0016; B29D 30/0603; B29D 2030/0027; B29D 2030/0022

(57) ABSTRACT

A device and a method for handling tires, as well as a tire curing press including a device of this type. The device for handling tires includes a fork which can be moved under a vulcanized tire in a tire curing press, such that the tire can be taken up by the fork and unloaded from the vulcanization chamber of the tire curing press.

The invention relates to a device for handling tires, which is designed in particular for unloading a tire curing press.

In addition, the invention relates to a tire curing press having a device for handling tires.

Furthermore, the invention relates to a method for handling tires by which a tire curing press is unloaded.

Tire curing presses are used for producing tires by vulcanizing green tires and have at least one vulcanizing chamber. The green tires have to be loaded into the vulcanizing chamber and the tires have to be unloaded from the vulcanizing is chamber after the vulcanization has taken place. Used for this purpose are devices for handling tires which, depending on the embodiment, can be used as loaders, unloaders or as loaders and unloaders of at least one vulcanizing chamber in each case.

At present, complex devices for handling tires, which are sometimes expensive to produce and laborious to maintain, are used both for loading and unloading the vulcanizing chamber.

These complex devices for handling tires, for example known from WO 2016 206 670 A1, have grippers with which, by clamping the tires in the region of the beads, the tires or the green tires can be clamped from the inside and can thereby be taken up.

This functionality requires a relatively complex mechanical construction of the grippers, and consequently also of the corresponding devices for handling tires, which is also accompanied by a great weight.

These great weights must be moved during the loading and unloading operation, and so the energy consumption of the corresponding devices is also higher.

However, in particular when unloading vulcanized tires from the vulcanizing chamber of a tire curing press, there are often no such high requirements for the precision of the handling and for the careful treatment of the tires. This is especially the case if the vulcanized tires are not intended to be passed on to a post-treatment device (for example a post cure inflator), but are merely intended to be set down on a transporting device or at an intermediate storage place.

One object of the invention is therefore to provide a device for handling tires that has improved properties with regard to weight, maintenance and/or production.

This object is achieved according to the invention by a device for handling tires according to patent claim 1.

A further object of the invention is to provide an improved tire curing press with regard to a device for handling tires.

This object is achieved according to the invention by a tire curing press according to patent claim 7.

A further object of the invention is to provide a method for handling tires which allows the use of a device for handling tires according to the invention in the unloading of the vulcanizing chamber of a tire curing press.

This object is achieved by a method for handling tires according to patent claim 14.

The features of a device for handling tires that are disclosed in the text which follows form part of the invention both individually and in all feasible combinations.

A device for handling tires according to the invention has at least one fork, which can be moved along a vertical axis and can be pivoted in the horizontal direction.

The fork is designed for receiving a tire on a support formed on the upper side of the fork.

In an advantageous embodiment of the invention, the fork is divided in two and has a free central region and an open side.

In a particularly preferred embodiment, for this purpose the fork is of a U-, or C- or V-shaped form in the horizontal direction or has a part which is correspondingly designed.

Tire curing presses generally have in their vulcanizing chamber a central mechanism on which the green tire or the tire can be fixed within the vulcanizing chamber and can be subjected to pressure from inside. For this purpose, such a central mechanism has for example tubes which can be moved out of a base plate bounding the vulcanizing chamber in the downward direction, are arranged in one another and on which clamping plates are fastened.

With the aid of such a central mechanism, a vulcanized tire can be raised from the base plate of a vulcanizing chamber. However, the extended part of the central mechanism is then located centrally under the raised tire.

The open side and the free central region of the fork of a device for handling tires according to the invention allows the fork to reach around the central mechanism and to offer a sufficiently large support for the tire, allowing it to rest dependably on the take-up of the fork.

The opening of the fork on the open side and the free central region are in this case of such great dimensions that even the largest elements of the central mechanism, which are generally the clamping plates, fit through the opening with some play.

The dimensions of the fork as a whole and the shape of the arms of the fork are made such that, while taking into consideration the required size of the free central region and the open side, the arms lie as closely as possible against the tire bead when a tire is resting on the support of the fork.

In one embodiment of the invention, the fork is produced as a welded part from steel tubes.

In a preferred embodiment of the invention, the fork is free of movable parts.

The vertical moving of the fork of a device for handling tires according to the invention is realized with the aid of a vertical drive, with which the fork is movable along a vertical guide.

A device for handling tires according to the invention advantageously has a vertical column on which the vertical guide is fastened and which carries the device for handling tires.

The pivoting of the fork of a device for handling tires according to the invention is realized with the aid of a pivoting drive, with which the fork is pivotable in the horizontal direction about a vertical axis.

In one embodiment of the invention, the pivoting of the fork takes place pneumatically with absorbers.

In one embodiment of the invention, the pivoting-in angle can be set by limiting the maximum stroke of the pivoting cylinder with the aid of the setting of the shock absorber.

In one embodiment of the invention, the adaptation of the device for handling tires to different tire sizes is made possible by setting the pivoting-in angle. For this purpose, the distance of the arms of the fork from one another increases in the direction of the open side and the distance between the arms of the fork in the region of the tire bead of the respective tire can be set by the pivoting-in angle.

As a result, in one embodiment of the invention, tires in a size range of approximately 15 to 25 inches can be dependably handled by a device for handling tires.

In embodiments of the invention, the vertical guide of the device for handling tires is designed as a round guide comprising a rod on which the fork is mounted vertically displaceably with the aid of a holder.

In other embodiments of the invention, the guide is designed as a profile, for example a hollow profile, or as a rail, for example a hat-like rail, on which a guiding carriage or slide on which the fork is fastened is mounted vertically displaceably.

In order that the pivoting drive together with the fork is vertically displaceable, this drive is also displaceably mounted on the guide.

In a preferred embodiment of the invention, the pivoting drive has a bearing device, by way of which it is mounted on the guide. In order to secure the pivoting drive to prevent it from turning in the horizontal direction, in order that only the fork is pivotable, in advantageous embodiments of the invention the pivoting drive is blocked in the horizontal direction by means of a blocking device.

In embodiments of the invention, such a blocking device is designed as a roller or as a sliding shoe, which is for example supported on the vertical column of the device for handling tires.

In one embodiment of the invention, the vertical drive is realized as a hydraulic drive with cylinders.

In one embodiment of the invention, the positions “pivoting-in position”, “pivoting-out position” and “setting-down position” are set in a fixed manner by mechanical stops in the vertical drive and/or the vertical guide.

One advantage over devices for handling tires having a gripper is that the lifting movements of the fork do not have to be synchronized with the upper clamping plate of the central mechanism of the vulcanizing chamber because the bladder is extended before the fork lifts the tire over the central mechanism.

As a result, the use of initiators instead of displacement measuring systems (DMS) is also made possible. This is implemented in embodiments of the invention.

In one embodiment of the invention, the pivoting-in angle is universal and independent of the position of the pressure plate. This is made possible by the fact that the gap between the lower mold shell and the lower clamping ring that is created by the breaking-out stroke is chosen to be large enough that the fork fits into this gap in every position of the closing-force cylinders of the tire curing press.

In one embodiment of the invention, the device for handling tires is designed for unloading from two vulcanizing chambers, for example the two vulcanizing chambers of a double curing press.

In one embodiment of the invention, for this purpose the device for handling tires has a double fork, which has an open side in both directions of rotation in the horizontal plane and a free central region.

In another embodiment of the invention, for this purpose the fork is pivotable by 180° about a horizontally aligned axis.

With a device for handling tires according to the invention, a simple and robust construction is realized, inherently not requiring any great accuracies.

A tire curing press according to the invention has at least one device for handling tires according to the invention as set out to the foregoing description.

In embodiments according to the invention of a tire curing press, by contrast with the prior art, when moving the tire on the fork into the pivoting-out position, no “holding firm” of the base plate is required because of its own weight, since the central mechanism together with the bladder is supported in the base plate (heating plate). This ensures that, when during the upward movement of the fork a tire that sticks and causes a force acting upward in the same direction on the central mechanism, the lower clamping ring does not lift the base plate off with it by the cylinders, which can happen in the case of tire curing presses in which the central mechanism is supported against the lower part of the press.

In an advantageous configuration of a tire curing press according to the invention, it has at least one roller table for transporting away the tires unloaded from the vulcanizing chamber.

In order that the tire can be set down by the fork on the roller table, the fork must pass through the roller table if the tire cannot be unloaded from the fork by turning or tilting it. For this purpose, in a preferred embodiment of the invention, some of the rollers of a roller table are divided into roller segments in the offloading region, so that in the roller table there is a clearance that corresponds to the contour of the fork.

In a preferred embodiment of the invention, the clearance in the offloading region of the roller table is designed to be somewhat larger than the outer contour of the fork, so that, when the fork passes through the roller table, a certain distance between the rollers or the roller segments and the fork is maintained.

In one embodiment of the invention, the roller table runs away from the tire curing press in a descending manner.

In an advantageous embodiment of the invention, the slope of the roller table is in this case chosen such that a tire set down on the roller table in the offloading region is moved along the roller table by the gravitational force acting on the tire. In embodiments of the invention, for this purpose the slope is approximately between 10° and 15°.

In one embodiment of the invention, at least one waiting position is provided in the region of a roller table with the aid of at least one arresting device. The at least one arresting device can be put into an arresting state and an open state, a tire that has been set down on the roller table being kept in an assigned waiting position in the arresting state of the at least one arresting device and a tire that has been set down on the roller table being able to leave the assigned waiting position or pass it in the open state of the at least one arresting device.

In one embodiment of the invention, the arresting device has at least one arresting element, which can extend upward from the rolling plane of the roller table and against which there lies a tire lying on the roller table in the assigned waiting position in the arresting state of the arresting device. For putting the arresting device into the open state, the at least one arresting element can be moved under the rolling plane of the roller table, so that a tire rolling on the roller table can pass the arresting device unhindered.

A method for handling tires according to the invention serves for unloading a tire curing press and has at least the following steps, the vulcanizing chamber of the respective tire curing press initially being open:
moving the fork of a device for handling tires in the vertical direction into a pivoting-in position
pivoting in the fork under a tire located in the open vulcanizing chamber
moving the fork upward into the pivoting-out position, thereby taking up the tire on the take-up of the fork
pivoting out the fork with the tire lying on the fork out of the vulcanizing chamber
moving the fork downward into the setting down position and setting down the tire

In an advantageous embodiment of the method according to the invention, it is designed as a method for unloading a tire curing press with a device for handling tires having a fork and, in addition to the method steps directed at the device for handling tires, also comprises the method steps necessary for unloading in the region of the vulcanizing chamber of the tire curing press.

The vulcanizing chamber of the respective tire curing press is initially open and the vulcanized tire is broken out from the mold or the mold parts. The method steps necessary for this may also be carried out after the moving or advantageously during the moving of the fork into the pivoting-in position, but must have taken place before the pivoting-in of the fork.

The steps comprise the opening of the vulcanizing chamber, the breaking out of the tire from the mold, the retracting of the mold segments and the raising of the tire with the central mechanism of the respective vulcanizing chamber, so that the tire is accessible from the sides and, apart from the region occupied by the central mechanism, from below and is kept at a sufficient distance above the base plate of the vulcanizing chamber. The distance is sufficient if it corresponds at least to the height of the fork of the device for handling tires plus the thickness of the lower half of a centrally divided mold and a certain reserve. The additionally required reserve is dependent on the accuracy of the device for handling tires when approaching the pivoting-in position. In one embodiment of the invention, the distance of the tire above the base plate of the vulcanizing chamber that is created by the stroke of the central mechanism is approximately 400 mm, the thickness of the lower half of the mold being approximately 200 mm.

The tire curing press to be unloaded has a central mechanism, with which a tire can be fixed on the inside and can be raised.

In one embodiment, the central mechanism has a lower clamping plate and an upper clamping plate, with which the tire can be fixed in a clamping manner. Otherwise, in the embodiment as a method for unloading a tire curing press, the method for handling tires comprises the following method steps:
moving the fork of a device for handling tires in the vertical direction into a pivoting-in position
raising the tire in the open vulcanizing chamber with the aid of the central is mechanism
pivoting in the fork under a tire located in the open vulcanizing chamber, in particular under the lower clamping plate of the central mechanism
releasing the tire by undoing the fixing of the tire by the central mechanism
moving the fork upward into the pivoting-out position, thereby taking up the tire on the support of the fork
pivoting out the fork with the tire lying on the fork out of the vulcanizing chamber
moving the fork downward into the setting-down position and setting down the tire

If the central mechanism has clamping plates for fixing the tire, the releasing of the tire takes place by moving of the clamping plates. For this purpose, in one embodiment the method for handling tires according to the invention has the steps of moving the lower clamping part into the lower position and extending the upper clamping plate. In a preferred embodiment, the extending of the upper clamping plate takes place at the same time as the moving of the fork upward into the pivoting-out position.

If the central mechanism of the vulcanizing chamber is equipped with a bladder for subjecting the tire to pressure from the inside, the bladder is extended before the take-up of the tire on the support of the fork by the moving of the fork from the height of the pivoting-in position into the pivoting-out position, so that the tire can be moved over the bladder in the vertical direction without any friction (releasing the tire). In an advantageous embodiment of the method, the extending of the bladder takes place at the same time as the moving of the lower clamping plate into the lower position.

In principle, the extending of the bladder takes place by downward moving of the lower clamping plate and upward moving of the upper clamping plate by the extending stroke. The moving of the clamping plates for extending the bladder may take place at the same time or one after the other. For unloading, a partial extension of the bladder by moving of the lower clamping plate is generally sufficient. However, the efficiency of the tire curing press can be improved by the bladder already being completely extended immediately after the pivoting out, since this is required for loading quickly and immediately after the unloading of the vulcanizing chamber.

In embodiments of the invention, the extension stroke (stroke of the upper clamping plate to extend the bladder) is approximately 750 mm to 1000 mm.

After the pivoting out of the fork out of the vulcanizing chamber, the operation of loading the curing press with a green tire can already be performed. If the central mechanism of the vulcanizing chamber is equipped with a bladder, the loading is possible over the extended bladder.

In the case of a tire curing press having a roller table for transporting away the tires, the setting down of the tire takes place in the setting-down region on the roller table. For this purpose, the fork passes through the roller table into a position lying below the roller table, the tire staying on the roller table.

As soon as the tire has rolled on the roller table out of the region above the fork, the fork can be moved upward again over the roller table, for example into the pivoting-in position.

In advantageous configurations of the method for handling tires according to the invention, the cycle time of a tire curing press can be reduced in comparison with the use of handling devices with a gripper by approximately 5 to 20 seconds. This is achievable in particular by the vulcanizing chamber being able to be loaded again immediately after unloading by the pivoting out of the fork with the tire taken up on it over the extended bladder.

In the figures described in the text which follows, exemplary embodiments of the invention are represented. In the figures:

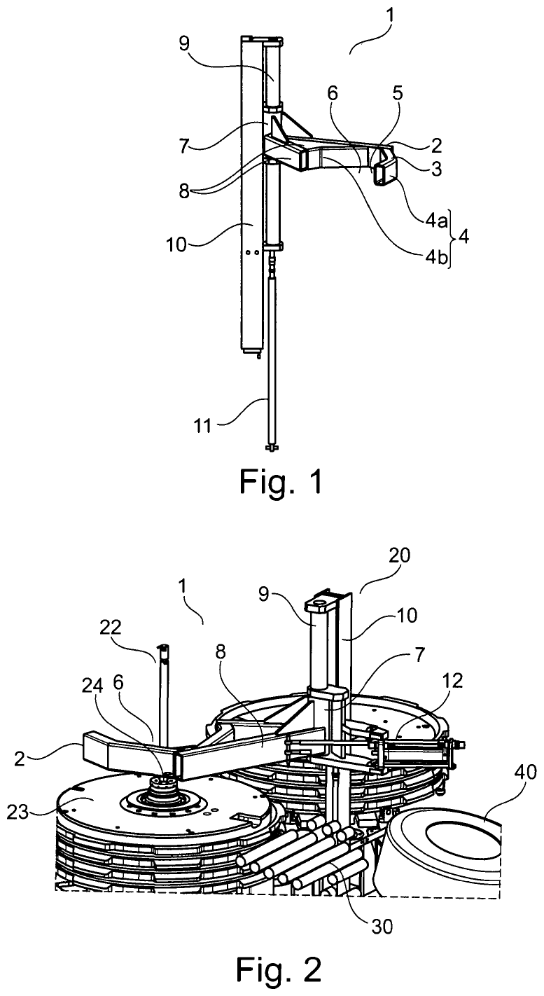

FIG. 1: shows a perspective view of an embodiment according to the invention of a device for handling tires,

FIG. 2: shows a perspective view of a detail of a tire curing press according to the invention, having a device for handling tires according to the invention and a roller table,

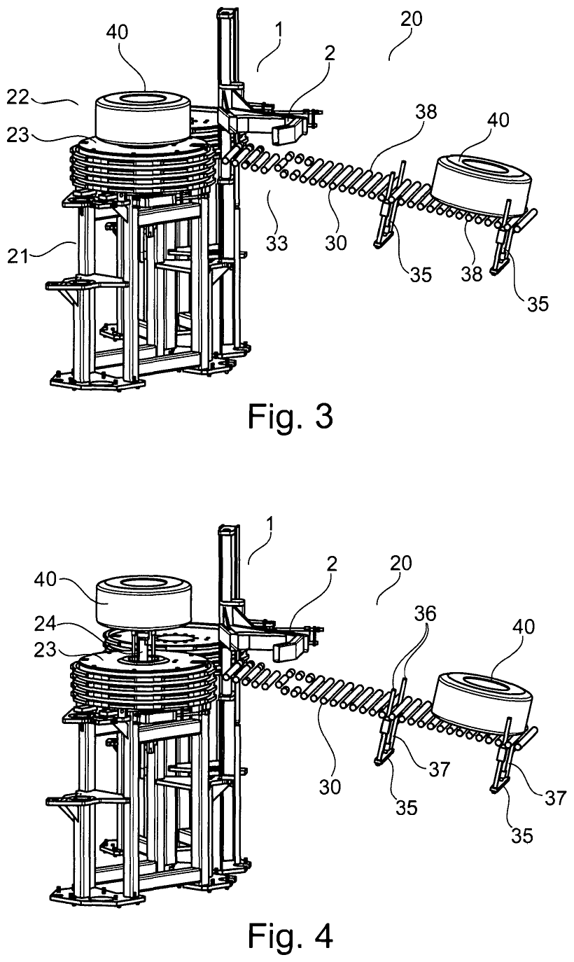

FIGS. 3-11: show perspective views of a larger detail of the tire curing press represented in FIG. 2 in various operating states, in the implementation of a method for handling tires according to the invention,

FIG. 12: shows the tire curing press represented in FIGS. 2 to 11 in a plan view,

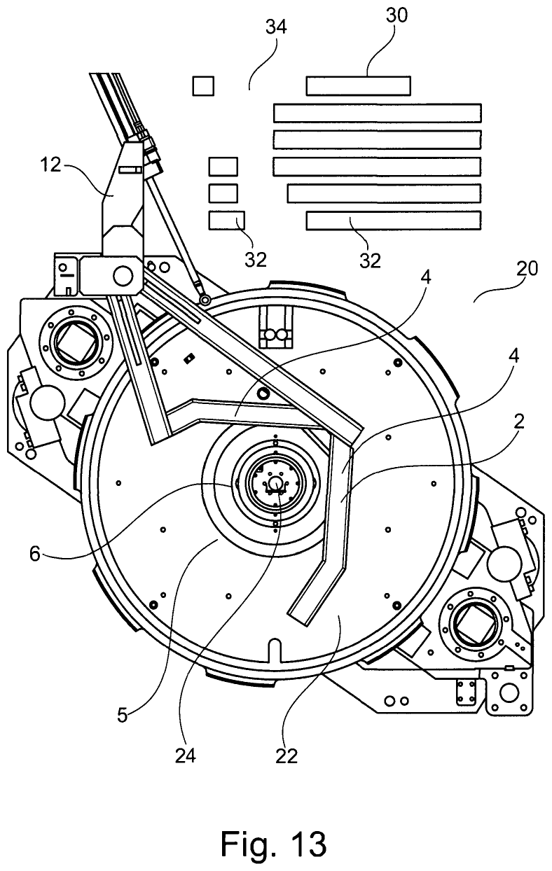

FIG. 13: shows a view of a detail of the plan view represented in FIG. 12, with the fork pivoted into the vulcanizing chamber and

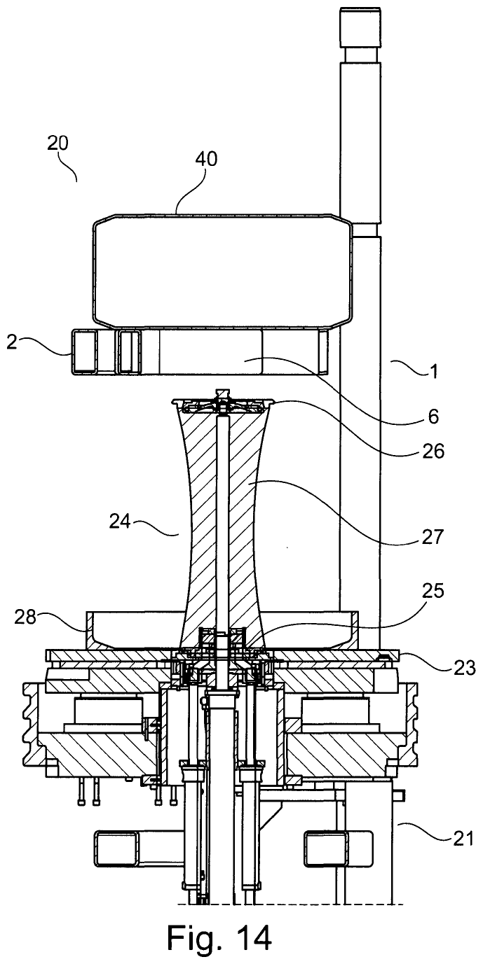

FIG. 14: shows a representation in the manner of a detail of a section through a tire curing press according to the invention, with an open vulcanizing chamber.

In FIG. 1, an embodiment according to the invention of a device for handling tires (1) is represented in a perspective view. The device for handling tires (1) has a fork (2), the upper side of which at least in certain regions forms a support (3), on which a tire (40) can be taken up. The fork (2) is formed by a first arm (4a) and a second arm (4b), the fork (2) having an open side (5) and a free central region (6) between the arms (4). The fork (2) is movably mounted on a vertical guide (9) with the aid of a holder (7), which is connected to the arms (4) by a connecting device (8) realized in the embodiment shown by two struts. The vertical guide (9) is connected in a fixed manner to a vertical column (10), which carries the device for handling tires (1) and absorbs and dissipates the forces occurring during operation.

The fork (2) is movable in the vertical direction along the vertical guide (9) with the aid of a vertical drive (11).

In the embodiment represented of the invention, the arms (4) and the connecting device (8) of the fork (2) are designed as steel tubes with a rectangular cross section, which are welded to one another.

FIG. 2 shows a perspective view of a detail of a tire curing press (20) according to the invention, having a device for handling tires (1) according to the invention and a roller table (30), on which a tire (40) rests.

Various components of the tire curing press (20) that are not of direct importance for the present invention have been omitted to simplify the representations, even if they are absolutely necessary for the actual operation of the tire curing press (40).

It can also be seen in this view that the device for handling tires (1) has a pivoting drive (12), with which the fork (2) is pivotable in the horizontal direction about a vertical axis running through the vertical guide (9). For this purpose, the holder (7) of the fork (2) is rotatably mounted on the vertical guide (9), while the pivoting drive (12) is rigidly connected to the vertical guide (9) in the horizontal direction on a bearing device which is designed in the manner of a yoke and reaches around the holder (7) of the fork (2) and on which the drive is only movable together with the fork (2) in the vertical direction on the vertical guide (9). This is realized for example by a blocking device, which supports the yoke-like bearing device against the vertical column (10).

In FIG. 2, the fork (2) has been pivoted into the vulcanizing chamber (22) of the tire curing press (20). A further vulcanizing chamber (22) of the tire curing press (20) can be seen in the background, since it is a double curing press.

Through the free central region (6) of the fork (2), the extended central mechanism (24) of the vulcanizing chamber (22) extends in the vertical direction out of the base plate (23) of the vulcanizing chamber (22).

Furthermore, the tire curing press (20) has a roller table (30), on which vulcanized tires (40) can be set down.

In FIGS. 3 to 11, perspective views of a larger detail of the tire curing press (20) that is represented in FIG. 2 are represented in various operating states in the implementation of a method for handling tires (40) according to the invention.

In FIG. 3, the vulcanizing chamber (22) of the tire curing press (20) has already been opened. The fork (2) of the device for handling tires (1) has been moved in the vertical direction into the pivoting-in position. The vulcanized tire (40) lies on the base plate (23) of the vulcanizing chamber (22). Under the base plate (23), the framework (21) of the tire curing press (20) can be seen. Inside the tire (40), the bladder (not represented) expands and clamps the tire (40) from the inside.

The fork (2) is located above the setting-down region (33) of the roller table (30). On the roller table, a vulcanized tire (40) already unloaded from the vulcanizing chamber (22) is in a waiting position (38), the tire (40) being kept in the waiting position (38) with the aid of an arresting device (35). Altogether, the roller table (30) represented has two waiting positions (38), each equipped with an arresting device (35).

In FIG. 4, the tire (40) that is in the vulcanizing chamber (22) has been broken out of the mold (not represented) and moved upward with the aid of the central mechanism (24). The mold segments (not represented) are retracted.

The arresting devices (35) each have two arresting elements (36), which are realized as rods protruding out of the rolling plane of the roller table (30). The arresting elements (36) can be extended out of the rolling plane of the roller table (30) by an arresting drive (37) for each arresting device (35) (arrested state) or can be retracted under the rolling plane (open state).

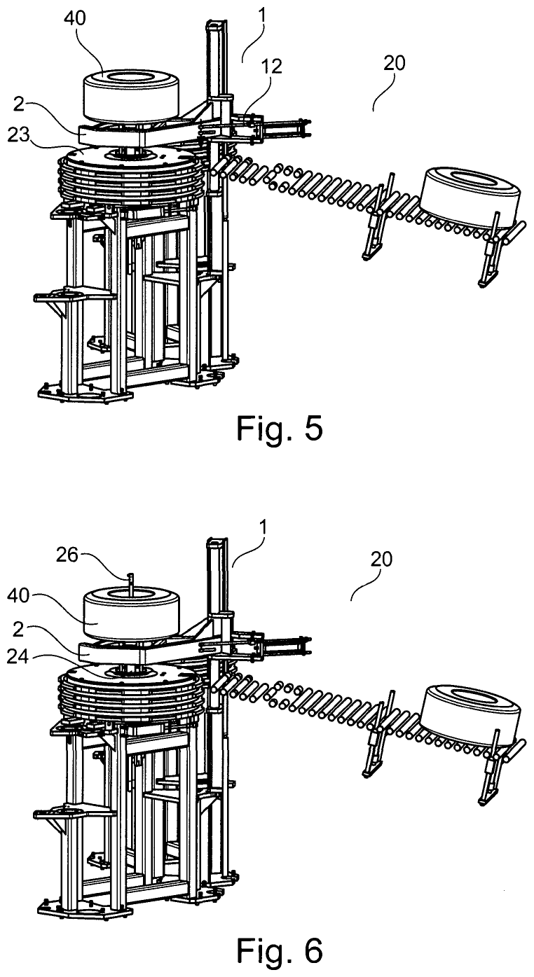

In FIG. 5, the fork (2) has been pivoted in with the aid of the pivoting drive (12) into the vulcanizing chamber (22) of the tire curing press (20). The pivoting in takes place in this case below the lower clamping plate (not represented) of the central mechanism (24) of the vulcanizing chamber (32), so that the fork (2) is located between the base plate (23) and the tire (40).

In FIG. 6, the bladder (not represented) is extended by moving of the lower clamping plate (not represented) downward into the lower position in the region of the base plate (23) and of the upper clamping plate (not represented) upward, which is arranged at the upper end (26) of the central mechanism (24) that is then projecting up out of the tire (40). As a result, the tire (40) is no longer fixed in a clamping manner from the inside by the bladder and is movable in the vertical direction.

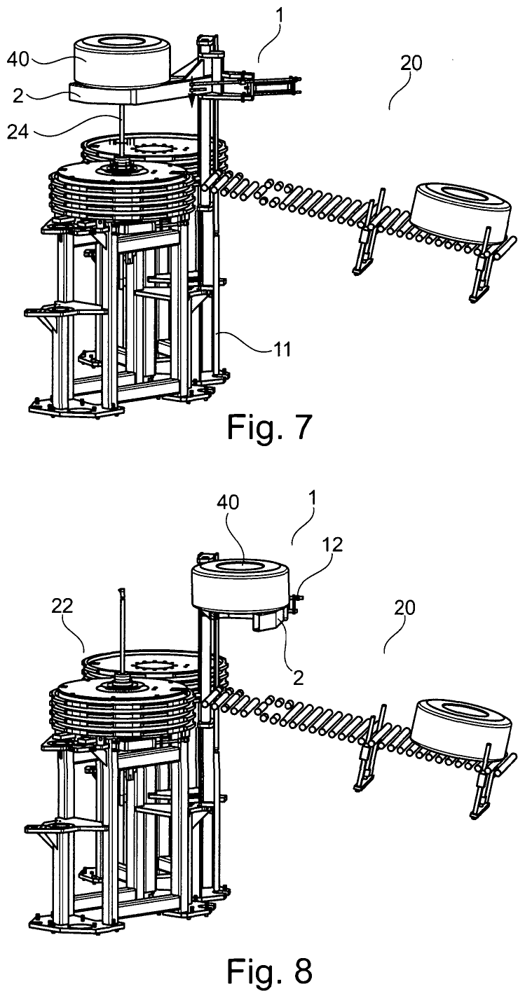

In FIG. 7, the fork (2) has been moved upward with the aid of the vertical drive (11) into the pivoting-out position, in which the highest point of the extended central mechanism (24) lies under the fork (22). During the upward moving of the fork (2), the tire (40) was taken up on the support (3) of the fork (2) and now rests on it.

In FIG. 8, the fork (2) with the resting tire (40) has been pivoted out of the vulcanizing chamber (22) of the tire curing press (20) with the aid of the pivoting drive (12). Since the vulcanizing chamber (22) is then free, it can be loaded again with a green tire.

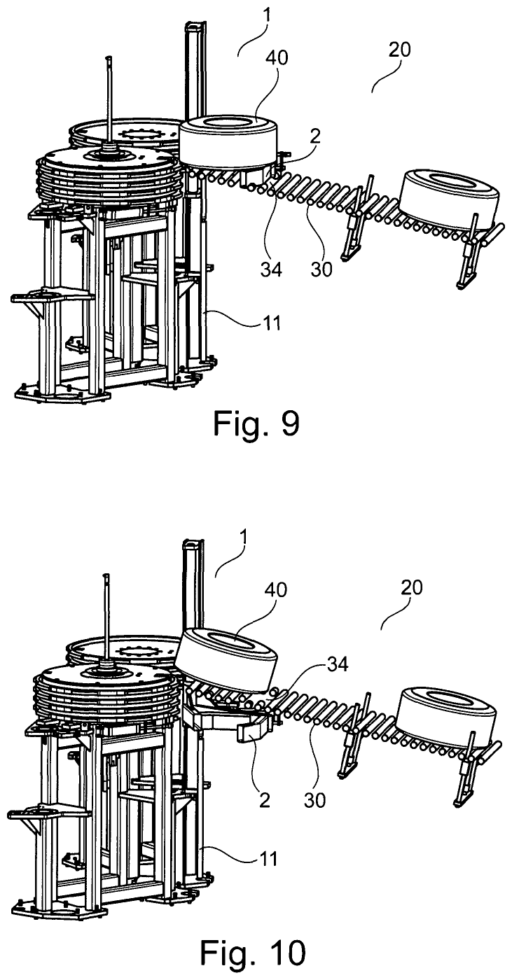

In FIG. 9, the fork (2) of the device for handling tires (1) has already been moved downward with the aid of the vertical drive (11), but has still not yet reached the setting-down position. The fork (2) goes straight into the clearance (34) realized in the setting-down region (33) of the roller table (30) and the tire (40) still rests on the support (3) of the fork (2).

In FIG. 10, the fork (2) has been moved with the aid of the vertical drive (11) into the setting-down position under the roller table (30). The tire (40) is larger than the fork (2) or has a different contour, so that it does not pass through the roller table (30) with the fork (2), but is set down on it in the setting-down region (33).

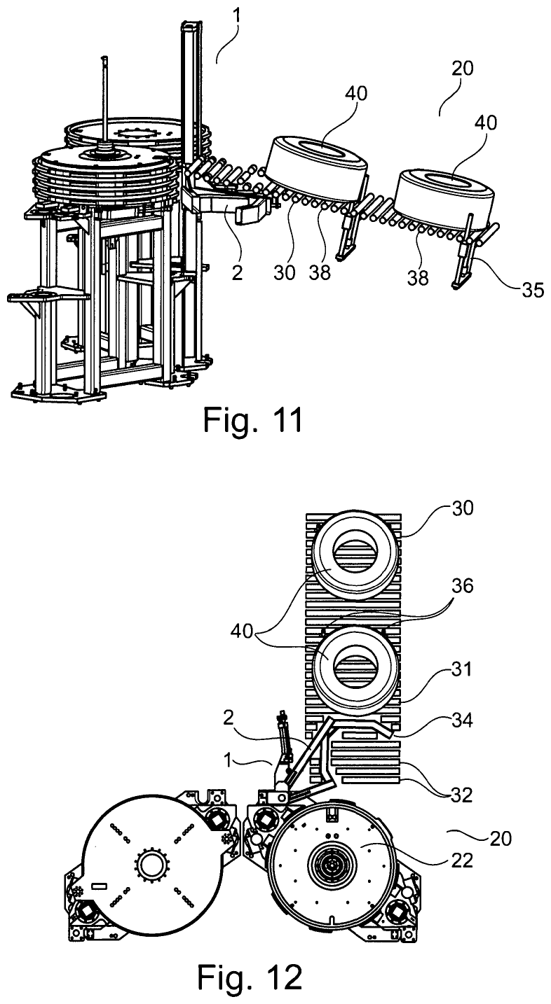

In FIG. 11, the tire (40) previously set down in the setting-down region (33) has been rolled into a waiting position (38) on the roller table (30), which descends away from the vulcanizing chamber (22) of the tire curing press (20).

FIG. 12 shows in a plan view the tire curing press (20) represented in FIGS. 2 to 11 according to the operating state shown in FIG. 11.

On the roller table (30), formed by a multiplicity of rollers (33) arranged next to one another, two tires (40) respectively lie in a waiting position (38), in which the tires (40) are kept with the aid of the arresting elements (36) of the respectively assigned arresting device (35).

In the setting-down region (33) of the roller table (30), the clearance (34) can be seen, corresponding to the shape of the fork (2) and realized by the arrangement of roller segments (32) and corresponding distances in the direction of the axis of rotation of the roller segments (32).

In FIG. 13, a view of a detail of the plan view that is represented in FIG. 12 is shown, with a fork (2) of the device for handling tires (1) pivoted into the vulcanizing chamber (22) of the tire curing press (20).

It can be seen well that the open side (5) and the free central region (6) of the fork (2) are required to reach around the central mechanism (24) in the pivoted-in position and at the same time to ensure dependable take-up of a tire (40), not represented here, on the support (3) formed with the aid of the fork (2).

FIG. 14 shows a representation in the form of a detail of a section through an embodiment of a tire curing press (20) according to the invention with an open vulcanizing chamber (22). The tire (40) rests on the fork (2) of the device for handling tires (1), the fork (2) already having been moved into the pivoting-out position. In this case, the underside of the fork (2) is located above the upper end of the central mechanism (24) in the region of the upper clamping plate (26), so that the central mechanism (24) does not lie in the pivoting path of the fork (2) during the pivoting out.

Also visible in this representation is the bladder (27), which has been extended by the upward moving of the upper clamping plate (26) and the downward moving of the lower clamping plate (25).

Arranged on the base plate (23) of the tire curing press (20) is the lower mold part (28) of the mold, from which the tire (40) was broken out after the vulcanization.

1-15. (canceled)

16. A device for handling tires, comprising: a vertical column; a vertical guide; a vertical drive; a pivoting drive; and a fork that is displaceable in a vertical direction on the vertical guide by the vertical drive and is pivotable in a horizontal direction by the pivoting drive.

17. The device for handling tires according claim 16, wherein the fork has a holder that is displaceably mounted in the vertical direction on the vertical guide.

18. The device for handling tires according claim 17, wherein the holder of the fork is additionally mounted pivotably in the horizontal direction on the vertical guide.

19. The device for handling tires according claim 16, wherein a support for a tire is provided on an upper side of the fork.

20. The device for handling tires according claim 19, wherein the support is configured to be divided in two, with a free central region and an open side.

21. The device for handling tires according claim 20, wherein the fork has two arms that laterally enclose the free central region with the exception of the open side.

22. A tire curing press, comprising: at least one vulcanizing chamber; a base plate that downwardly bounds the vulcanizing chair; a central mechanism assigned to the vulcanizing chamber and operative to raise a vulcanized tire from the base plate; and a device for handling tires according to claim 16.

23. The tire curing press according to claim 22, wherein the device for handling tires is configured to unload tires from the vulcanizing chamber.

24. The tire curing press according to claim 23, further comprising a roller table arranged to convey away the tires unloaded from the vulcanizing chamber.

25. The tire curing press according to claim 24, wherein the roller table slopes away in a downwardly descending manner from the tire curing press in the transporting direction of the tires.

26. The tire curing press according to claim 25, wherein the roller table is sloped so that a tire set down on the roller table rolls on the roller table as a result of the gravitational force acting on the tire.

27. The tire curing press according to claim 24, wherein the roller table has a setting-down region for setting down a tire, the setting-down region having a clearance in the roller table so that the fork of the device for handling tires is movable through the roller table in the vertical direction.

28. The tire curing press according to claim 24, further comprising an arresting device to keep the tire set down on the roller table in a waiting position.

29. A method for handling tires, comprising the steps of:
moving a fork of a device for handling tires in a vertical direction into a pivoting-in position;
pivoting in the fork under a tire located in an open vulcanizing chamber of a tire curing press;
moving the fork upward into a pivoting-out position, the tire being taken up on a support of the fork;
pivoting the fork with the tire lying on the fork out of the vulcanizing chamber of the tire curing press; and
moving the fork downward into a setting-down position and setting down the tire.

30. The method for handling tires according to claim 29, wherein the device for handling tires comprises a vertical column, a vertical guide, a vertical drive, a pivoting drive and the fork that is displaceable in the vertical direction on the vertical guide by the vertical drive and is pivotable in a horizontal direction by the pivoting drive.
